(19) United States
(12) Patent Application Publication
(10) Pub. No.: US 2006/0283940 A1
(43) Pub. Date: Dec. 21, 2006

(54) Multifunctional card reader

(75) Inventor: Hui-Lin Kuo, Taichung City (TW)

Correspondence Address: OLIFF & BERRIDGE, PLC, P.O. BOX 19928, ALEXANDRIA, VA, 22320, US

(73) Assignee: XAC AUTOMATION CORP., Hsinchu (TW)

(21) Appl. No.: 11/154,736

(22) Filed: Jun. 17, 2005

(51) Int. Cl. G06K 15/00

(52) U.S. Cl. 235/383

(57) ABSTRACT

The present invention discloses a multifunctional card reader, which is operated with a PIN-pad by a user, to offer a total self-service to the user. The multifunctional card reader comprises a holding portion, a first sensing device and a plurality of indicators. The holding portion holds the PIN-pad when the PIN-pad is not used. The first sensing device senses a payment card by a contactless technique and receives the account information stored on the payment card. The indicators inform the user of verification of account information.

### BACKGROUND OF THE INVENTION

1. Field of the Invention

The present invention relates to a multifunctional card reader operated with a PIN-pad and by a user, and more particularly to a multifunctional card reader having a hole to hold the PIN-pad in place and receiving different types of payment cards, which is especially suitable for transactions at point-of-sale.

2. Description of the Related Art

Referring to FIG. 1, a point-of-sale (POS) terminal 1 is the countertop device that is used to swipe payment cards, in doing so converting the data held on the magnetic stripe into an electronic format that can then be transmitted securely to the respective bank for authentication and settlement. Typically the device has an LCD/LED display 11 for prompting instructions, a numeric keyboard 12, a sensing device 13 for swiping the payment card, a receipt printer 14 for printing receipts and a collection of ports 15 for connecting the device to communication networks. For debit transactions in the US and for EMV (Europay-MasterCard-Visa) transactions throughout the rest of the world, the POS terminal 1 will be often connected to a numeric PIN-pad 2 by a cable 21, used for the customers to enter their four digit identifiers, i.e., personal identification number (PIN). The POS terminals have increasingly been deployed to perform debit card transactions in which the amount of the transaction is directly debited to the customer's bank account in an online transaction. Debit transactions generally require the customer to enter a PIN code on the PIN-pad 2 associated with the POS terminal 1. The PIN-pad 2 has a small LCD/LED display 22 for prompting some instructions to the customer and a small numeric keyboard 23 for keying in the PIN code.

In general, the POS terminal 1 is placed at the counter close to the clerk. At the time of payment, the customer gives the payment card to the clerk, and the clerk swipes the payment card and then the customer is required to input a PIN code on the PIN-pad 2 that is located near the customer (e.g., at customer's hand) to authenticate the transaction. During payment, the payment card may be within or out of sight of the customer, depending on the location of the POS terminal 1, but out of the customer's possession. Another type of PIN-pad 2, referring to FIG. 2, is developed, which keeps the payment within sight of the customer during payment. The PIN-pad 2 provides a sensing device 13 (in the form of the slot) for swiping the payment card. Moving the sensing device 13 from the POS terminal 1 of FIG. 1 to the PIN-pad 2 of FIG. 2 makes the customer feel comfortable and secure at the time of payment, but enlarges the size of the PIN-pad 2 and complicates the PIN-pad design. The PIN-pad 2 in FIG. 2 is similar to that in FIG. 1 except a slot, which is the sensing device 13 for swiping the payment card, is added.

To address security concerns and further develop electronic business, a smart card has been introduced as a payment tool. The smart card is a credit card sized device with electronic memory (i.e., IC chip) used for a variety of applications. Transaction at point-of-sale is one of these various applications. A tiny IC chip is embedded into a debit or credit card and provides both highly secure memory and complex processing capability. The IC chip holds the same personal data as magnetic stripes in other card types (for example, cardholder name, card number and expiry date). Another sensing device, in a form of slot (not shown), is combined into the PIN-pad 2 to accept the smart card and to receive the account information stored thereon. Some PIN-pad products are available with a smart card reader configured at the bottom of the PIN-pad 2. Such a design of PIN-pad 2 makes the customer feel secure and comfortable at the time of payment, but has the shortcomings of large size and complexity of PIN-pad design.

In addition, there is an increasing demand for facilitating the payment at point of sale, and thus a contactless payment tool is required. RFID (Radio Frequency Identification) is a developing technique used in payment transactions. RFID is a flexible technology that is convenient, easy to use, and well suited for automatic operation. It combines advantages not available with other identification technologies. RFID can be supplied as read-only or read/write, does not require contact or line-of-sight to operate, can function under a variety of environmental conditions, and provides a high level of data integrity. In addition, because the technology is difficult to counterfeit, RFID provides a high level of security. RFID is similar in concept to bar coding. Bar code systems use a reader and coded labels that are attached to an item, whereas RFID uses a reader (RFID reader) and special RFID devices that are attached to the item. Bar code uses optical signals to transfer information from the label to the reader; RFID uses RF signals to transfer information from the RFID device to the reader. Radio waves transfer data between an item to which an RFID device is attached and an RFID reader. The device can contain data about the item, such as what the item is, what time the device traveled through a certain zone, perhaps even a parameter such as temperature. RFID devices, such as a tag or label, can be attached to virtually anything—from a vehicle to a debit card.

When RFID technique is utilized in POS transaction, it is not feasible to design the RFID reader on the PIN-pad 2. The most important reason is that the area of the sensing device of the RFID reader cannot be shrunk to fit in the PIN-pad 2 to sense the RFID device effectively. Another reason is that combining the RFID reader with the PIN-pad 2 will complicate the design of the PIN-pad 2. Consequently, the size of the combined PIN-pad 2 violates the standards of handheld instruments and loses the benefits thereof. To take advantage of RFID technique as a contactless payment, it is necessary to locate the RFID reader properly to ensure effective sensing.

The PIN-pad 2 in FIG. 2 is equipped with some kinds of readers, such as a magnetic stripe reader and a smart card reader, which is heavier than that with only one function of PIN code input. There is usually not an appropriate room for the PIN-pad 2, when not used. The PIN-pad 2 is placed just around the POS terminal 1 or somewhere else after it has been returned by the customer. The PIN-pad 2 contains delicate internal instruments and is therefore sensitive to shock due to careless impact. Therefore, it is necessary to prepare space for the PIN-pad 2.

### SUMMARY OF THE INVENTION

The primary objective of the present invention is to provide a multifunctional card reader, which is operated with a PIN-pad by a user, to offer a fully self-service unit to the user. The secondary objective of the present invention is to provide a multifunctional card reader, which prepares space for the PIN-pad when the PIN-pad is not used. Another objective of the present invention is to provide a multifunctional card reader, which combines different types of readers of payment cards, thereby providing multiple-payment-choices to the user.

In order to achieve the objectives, the present invention discloses a multifunctional card reader, which is operated with a PIN-pad and by a user, comprising a holding portion holding the PIN-pad, at least one sensing device sensing a payment card and receiving the account information stored in the payment card. The multifunctional card reader holding the PIN-pad functions as a cradle for the PIN-pad. In embodiments, the multifunctional card reader offers any combination of a magnetic stripe reader, a smart card reader and a RFID reader.

### BRIEF DESCRIPTION OF THE DRAWINGS

The invention will be described according to the appended drawings in which:

FIG. 1 shows a Point-of-Sale terminal and a PIN-pad in prior art;

FIG. 2 shows a PIN-pad with a sensing device for swiping a magnetic stripe in prior art;

FIGS. 3(a)-(c) show the top plane view, the front view and the right side view, respectively, of one embodiment of the present invention of the multifunctional card reader;

FIG. 4 shows a PIN-pad held by the holding portion of one embodiment of the present invention of the multifunctional card reader; and

FIG. 5 is a functional block diagram of one embodiment of the present invention of the multifunctional card reader.

### PREFERRED EMBODIMENT OF THE PRESENT INVENTION

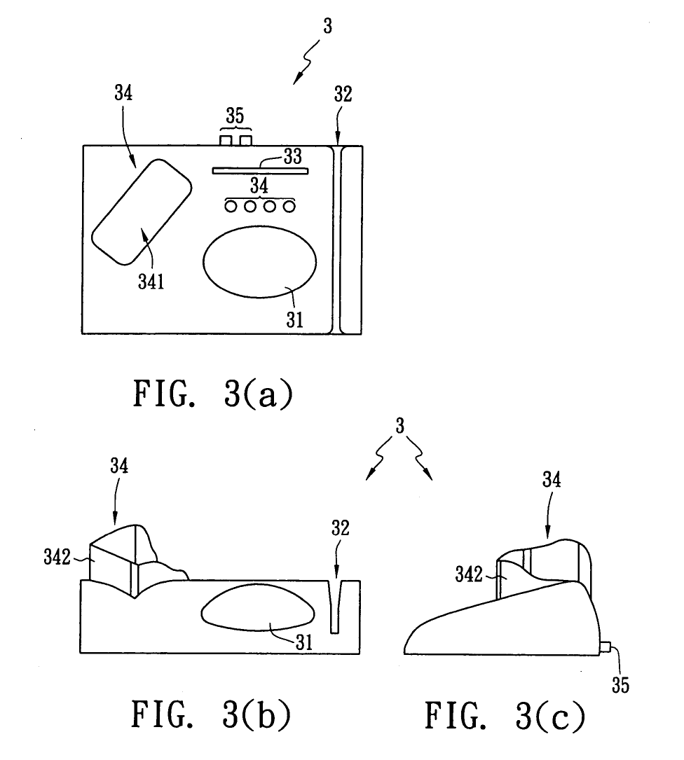

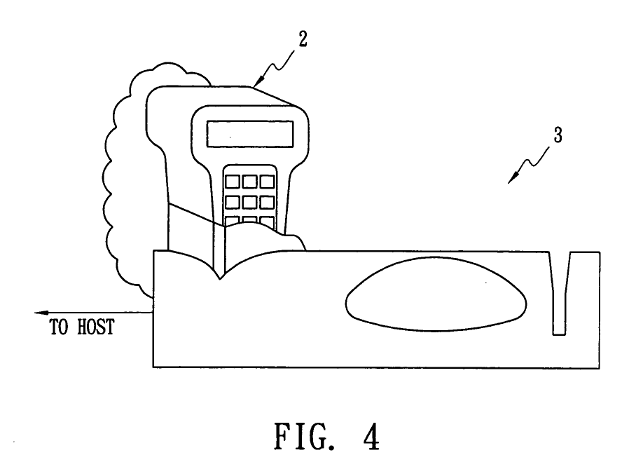

One embodiment of the present invention of the multifunctional card reader is shown in FIG. 3(a)-(c), which include a top plane view, a front view and a right side view of the multifunctional card reader 3, respectively. The multifunctional card reader 3 comprises a holding portion 34, a first sensing device 31, a second sensing device 32, a third sensing device 33, a plurality of indicators 34 and two connection ports 35. The holding portion 34 having a hole 341 is a part of the multifunctional card reader 3 to hold a PIN-pad (not shown) in place when the PIN-pad is not used. The size and shape of the hole 341 is designed to fit the PIN-pad. A thin wall 342 with a protrusion to attach to the inner wall of the hole 341 is used to hold the PIN-pad firmly, and keeps the PIN-pad from dropping when the clerk brings the multifunctional card reader 3 and the PIN-pad as a whole to the customer for making payment. The holding portion 34 provides a room for the PIN-pad and firmly and safely keeps the PIN-pad in place, which makes the customer feel respected when he/she receives the card reader 3 and the PIN-pad as a whole. FIG. 4 shows a PIN-pad 2 sitting in the hole 341 of the holding portion 34, referring to FIG. 3(a), of the multifunctional card reader 3.

The first sensing device 31 is a RFID reader implemented by a reader IC. The internal transmitter part of the first sensing device 31 is able to drive an antenna designed for proximity operating distance (up to 100 mm) directly without additional active circuitry. The receiver part of the first sensing device 31 provides a robust and efficient implementation of a demodulation and decoding circuitry for signals from ISO1443 compatible transponder. The first sensing device 31 provides a contactless way for transactions by payment cards with a RFID device (RFID tag). In one embodiment, the first sensing device is a MasterCard® PayPass™ reader.

The second sensing device 32 is a MSR (Magnetic Stripe Reader) implemented by a MSR circuitry to sense the payment card with a magnetic stripe. The payment card may be a debit card, a credit card and any payment card with the magnetic stripe storing account information. The third sensing device 33 is an SCR (smart card reader) implemented by SCR circuitry. A plurality of indicators 34 informs the user, by light or sound, of verification of the account information stored in the payment card. The number of the indictors 34 is not limited to four as shown in FIG. 3(a). One of the two connection ports 35 is connected to the Host and the other is connected to the PIN-pad.

The layout of the first sensing device 31, the second sensing device 32, the third sensing device 33, the indicators and the holding portion 34 is not limited to that in FIG. 3(a)-(c). Any combination of an RFID reader, a MSR and an SCR can be provided in the multifunctional card reader 3.

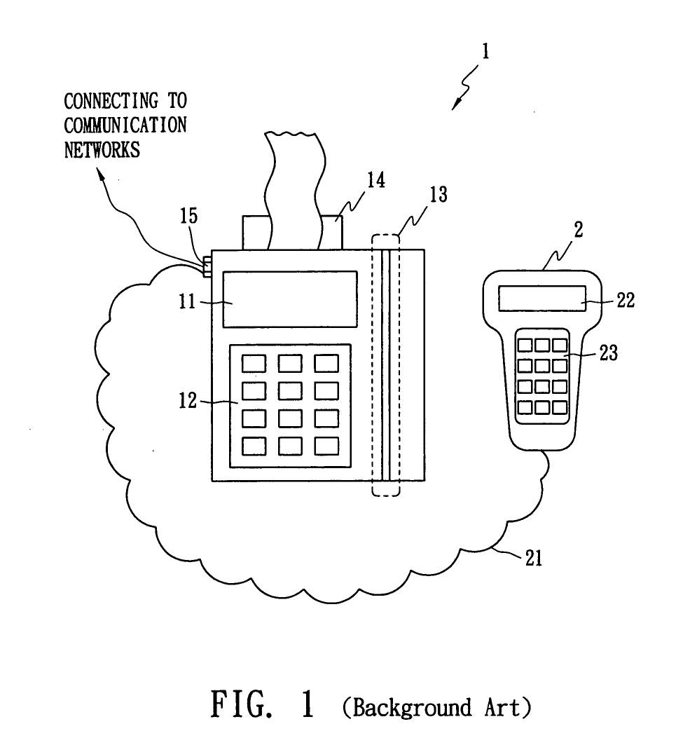

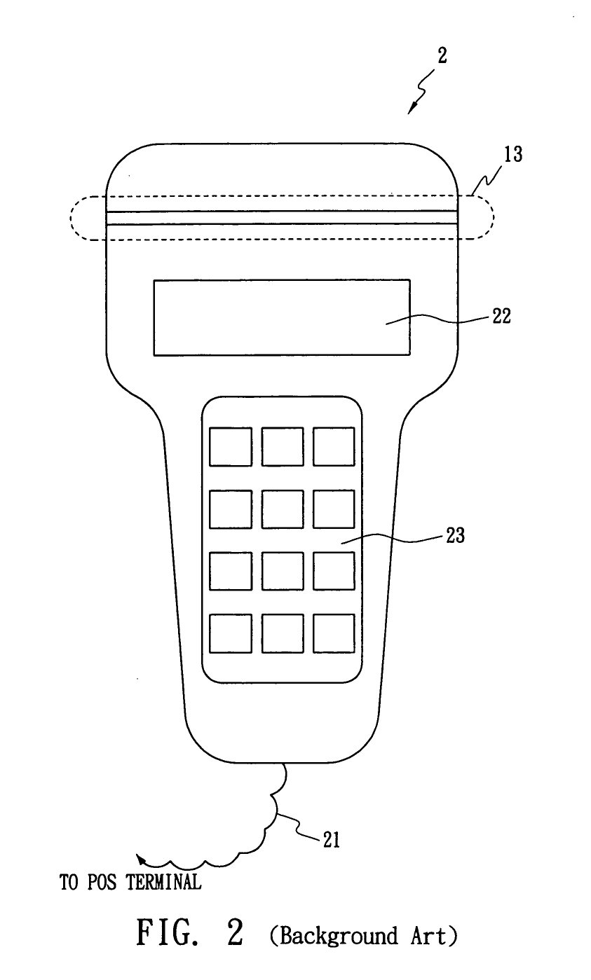

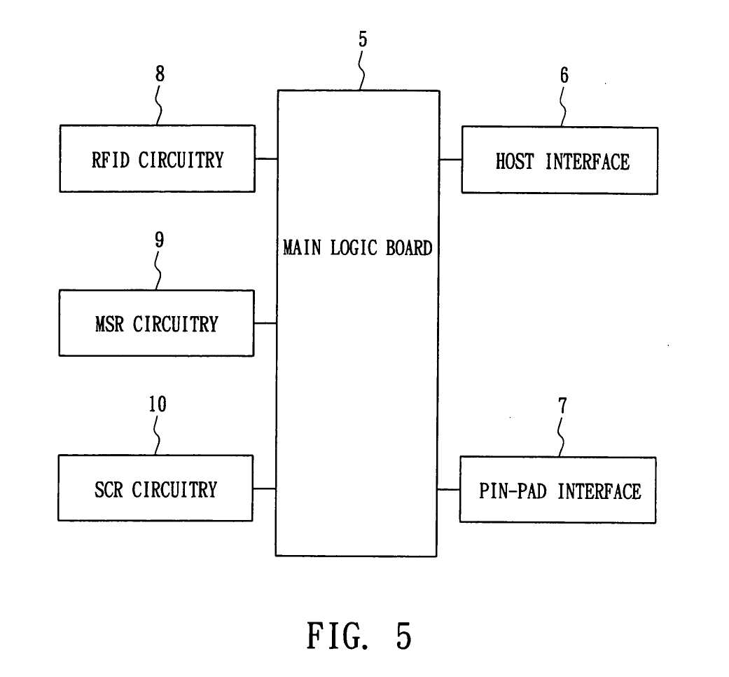

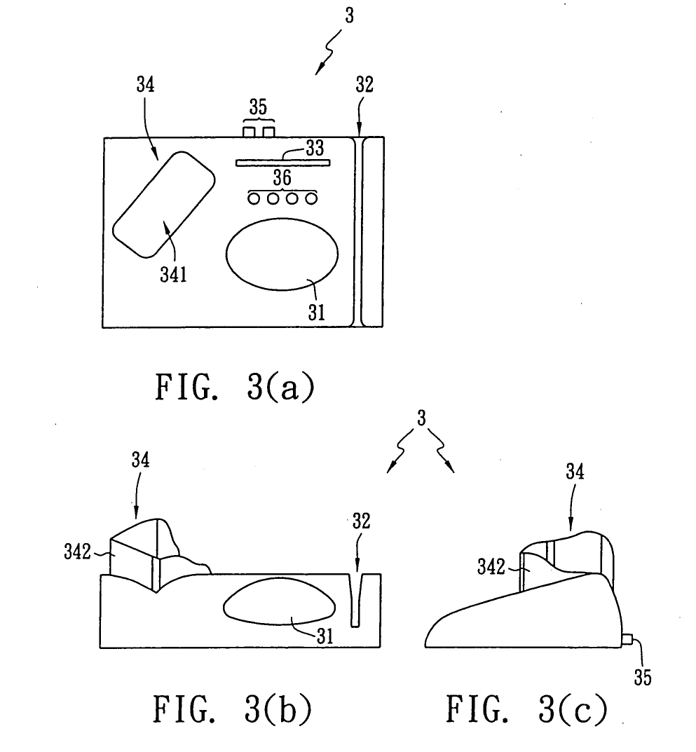

FIG. 5 is a functional block diagram of one embodiment of the present invention of the multifunctional card reader 3. One payment flow is described as follows. When the user makes payment with a payment card at point-of-sale, instructions issued from the host (not shown) is passed to the main logic board 5 through the host interface 6 and is displayed on the PIN-pad 2 through the PIN-pad interface 7. The displayed message includes the amount of expense and the prompt requesting for a PIN code. After taking a look at the displayed message, the user can pick up the PIN-pad 2 and chooses a proper payment card to pay. After any payment action has been taken, in which the user swipes a smart card, a credit card, a debit card or an RFID contactless card, the corresponding circuitry (RFIC circuitry 8, MSR circuitry 9 or SCR circuitry 10) receives the account information stored in the payment card and passes it to the bank through the main logic board 5 and the host interface 6. The PIN code of the users is requested through the PIN-pad 2 to authorize the transaction. When matching of the account information and the PIN code is verified, sound and/or light are emitted from the indicators 34 to inform the user the transaction is completed. When a non-matching failure occurs, a different sound and/or different light are emitted and an error message is shown in the small LCD/LEC display 22 (refer to FIG. 1).

Each operation of the user, such as picking up the PIN-pad 2 from the multifunctional card reader 3, swiping the payment card, keying in the PIN code on the small numeric keyboard 23 of the PIN-pad 2 (refer to FIG. 1), replacing the PIN-pad 2 to the multifunctional card reader 3, is within sight of the user and thus security and the feeling of the user are both improved. After the payment is completed, the multifunctional card reader 3 and the PIN-pad 2 are ready to serve the next user.

The above-described embodiments of the present invention are intended to be illustrative only. Numerous alternative embodiments may be devised by persons skilled in the art without departing from the scope of the following claims.

1. A multifunctional card reader used for point-of-sale and operated with a PIN-pad and by a user to offer a total self-service, comprising:
a holding portion used for holding the PIN-pad in place when the PIN-pad is not in use;
a sensor employing an RFID technique sensing a payment card and receiving account information stored in the payment card; and
wherein the PIN-pad is detachable from the holding portion when the multifunctional card reader receives a PIN-code from the PIN-pad, and the account information is transferred by wire.

2. (canceled)

3. The multifunctional card reader of claim 1, further comprising a sensor sensing the payment card with a magnetic stripe.

4. The multifunctional card reader of claim 1, further comprising a sensor sensing the payment card with an IC chip.

5. (canceled)

6. The multifunctional card reader of claim 1, further comprising a plurality of indicators informing the user of verifying the account information when the sensor employing the RFID technique is active.

7. The multifunctional card reader of claim 3, further comprising a plurality of indicators informing the user of verifying the account information when the sensor with a magnetic stripe is active.

8. The multifunctional card reader of claim 6, wherein one of the indicators emits light or sound.

9. The multifunctional card reader of claim 7, wherein one of the indicators emits light or sound.

10. The multifunctional card reader of claim 1, wherein the holding portion having a hole holding the PIN-pad.

11. The multifunctional card reader of claim 3, further comprising a sensor sensing the payment with an IC chip.

12. The multifunctional card reader of claim 11, further comprising a plurality of indicators informing the user of verifying the account information when the sensor employing the RFID technique is active.

13. The multifunctional card reader of claim 12, wherein one of the indicators emits light or sound.
